(19) United States
(12) Patent Application Publication
(10) Pub. No.: US 2026/0357442 A1
(43) Pub. Date: Nov. 12, 2026

(54) WATER ELECTROLYSIS USING ZERO-POINT ENERGY TO WEAKEN THE MOLECULAR BOND USING SELF-CANCELING WAVE TECHNOLOGY

(71) Applicant: UNITED ENERGIES DEVELOPMENT CORPORATION, Paradise Valley, AZ (US)

(72) Inventor: Denis Anthony Luz, Paradise Valley, AZ (US)

(73) Assignee: UNITED ENERGIES DEVELOPMENT CORPORATION, Paradise Valley, AZ (US)

(21) Appl. No.: 19/203,405

(22) Filed: May 9, 2025

(51) Int. Cl. C25B 1/04; C25B 9/05; C25B 9/65; C25B 11/046; C25B 15/08

(52) U.S. Cl. CPC C25B 1/04; C25B 9/05; C25B 9/65; C25B 11/046; C25B 15/083

(57) ABSTRACT

Some embodiments are directed to systems and methods for water electrolysis utilizing Zero-Point Energy (ZPE) to weaken the molecular bond of water (H2O) and reduce the required energy for electrolysis. A low-voltage charged stack of metal plates submerged in water generates self-canceling waves via the Casimir effect, weakening the molecular structure. This enables efficient production of hydrogen and oxygen gases with minimal energy consumption. The system operates near the point where the molecular bond is weakest, allowing renewable energy sources such as wind and solar to power the process. The hydrogen and oxygen produced can be captured for use in energy storage and as a cleaner alternative to fossil fuels, contributing to efforts to reduce reliance on hydrocarbons and combat climate change.

### CROSS-REFERENCE

None.

### TECHNICAL FIELD

Example embodiments generally relate to power generation systems and more particularly to providing an even source of electricity by storing power more efficiently in hydrogen.

### BACKGROUND

The present disclosure relates to systems and methods for water electrolysis utilizing Zero-Point Energy (ZPE) and self-canceling wave technology to weaken the molecular bond of water (H2O). Water electrolysis is the process of splitting the water molecule to produce hydrogen and oxygen gases. Traditionally, this process requires significant amounts of electricity, regardless of the method used, such as Alkaline, PEM (Permeable/Proton Exchange Membrane), or Solid Oxide electrolysis, due to the strength of the molecular bond in H2O.

### SUMMARY

Example embodiments relate to systems and methods for water electrolysis utilizing Zero-Point Energy (ZPE) and self-canceling wave technology to weaken the molecular bond of water (H2O). The system involves using low voltage charged metal plates submerged in water, generating self-canceling waves through the Casimir effect. This process weakens the molecular bond of water, reducing the energy required for electrolysis and producing a volatile mixture of hydrogen and oxygen (HHO gas). The hydrogen and oxygen gases are captured for various uses, including energy storage and as vehicle fuel.

Some embodiments of the present disclosure involve water electrolysis systems that use Zero-Point Energy (ZPE) to weaken the molecular bond of water. These systems employ low voltage charged metal plates submerged in water, generating self-canceling waves through the Casimir effect, which reduces the bond strength in water molecules. This allows for a more efficient electrolysis process by requiring less energy to split the water into hydrogen and oxygen gases.

Some embodiments describe systems where the electrolysis process is optimized to produce HHO gas, a volatile mixture of hydrogen and oxygen, that can be collected for various uses, such as energy storage and vehicle fuel. The system may also include a mechanism to control the process, ensuring that the molecular bond is weakened without prematurely producing HHO gas, allowing for the efficient capture and use of the pure gases.

Some embodiments include renewable energy integration, such as wind or solar power, to power the electrolysis process. The reduced energy requirements of the weakened molecular bonds make this method suitable for alternative energy sources, contributing to a more sustainable approach to hydrogen production.

Some embodiments highlight the application of hydrogen produced by the electrolysis process as a replacement for diesel fuel. This cleaner alternative fuel can be used in various industries, helping to eliminate the reliance on hydrocarbons, which are a primary cause of climate change.

Some embodiments further describe the scalability of the electrolysis system, making it adaptable for different industrial or environmental settings, from small-scale operations to large-scale hydrogen production facilities, all while maintaining low energy consumption and high efficiency.

### BRIEF DESCRIPTION OF THE DRAWINGS

A detailed description of the example embodiments is provided herein below by way of example only and with reference to the following drawings, in which:

FIG. 1 shows a schematic of the power system, showing the energy sources and hydrogen and oxygen storage to regenerate power;

FIG. 2 shows a block diagram of the power system, illustrating the key steps in the electrolysis process for producing hydrogen and oxygen gas from water; and

FIG. 3 shows a block diagram illustrating the method for producing hydrogen and oxygen gas, beginning with the application of low voltage current to metal plates submerged in water.

Similar reference numerals may be used in different figures to denote similar components.

### DETAILED DESCRIPTION OF EXEMPLARY EMBODIMENTS

The figures are described below. Before the embodiments are to be explained in detail, it is to be understood that the presently disclosed subject matter is not limited in application or process to the details stated, as there are other embodiments and methods of carrying out and practicing the presently disclosed subject matter than those described. As such, the language used below is not limiting and states what may be used but may not necessarily be completely exhaustive.

Throughout the specification, wherever practicable, like structures will be identified with reference numbers. In some figures, components, such as additional electrical connections or fasteners have been omitted for clarity in the drawings. Unless expressly stated otherwise, the term “or” means “either or both” such that “A or B” includes A alone, B alone, and both A and B together.

Although the example embodiments of methods and systems will be described in terms of various examples, it is to be understood that such methods and systems are not intended to be limiting. Various alterations and modifications will be readily apparent to those of skill in the art. Accordingly, it is intended that the appended claims be interpreted as covering all alterations and modifications that fall within the spirit and scope of the example embodiments.

Some of the example embodiments include or otherwise involve electrical power systems designed to manage and distribute power across various networks. The electrical systems may include, for example, one or more of utility grids, microgrids, industrial power networks, residential power distribution systems, renewable energy systems (e.g., solar, wind), or other energy delivery mechanisms. Power systems may include high-voltage transmission networks, medium-voltage distribution networks, or low-voltage residential and commercial systems. These networks can integrate renewable energy sources, conventional power plants, and energy storage systems to provide reliable and efficient power delivery.

Examples of electrical power networks may include, but are not limited to, smart grids, microgrids, virtual power plants (VPPs), distributed energy resource (DER) networks, energy storage systems (ESS), building energy management systems (BEMS), and electric vehicle (EV) charging networks. These networks are capable of balancing loads, integrating renewable energy, managing demand response, and ensuring power quality through intelligent grid management systems.

The power management devices and systems described are intended to cover all hardware and software capable of controlling, monitoring, and optimizing electrical distribution and consumption. This includes energy management systems (EMS), grid control software, load balancing algorithms, and hardware such as transformers, circuit breakers, inverters, and sensors. Exemplary embodiments may also encompass any hardware or software, whether currently known, related art, or later developed, that enables processors and control systems to implement the disclosed processes for electrical power management.

In this specification, the terms "voltage" and "power" are referring to related but distinct concepts within the context of electrical systems and may be used interchangeably where applicable.

The grouping of features in the description is not intended to imply that all such features are necessary in every embodiment. Instead, inventive subject matter may reside in individual features, and combinations of the described features may be used in various embodiments. Language referring to features, advantages, or combinations thereof is intended to be understood as applying to at least one embodiment, not necessarily to every embodiment. Features described as "comprising" or "including" are open-ended and allow for additional elements or method steps unless otherwise specified.

Some embodiments of the present disclosure involve water electrolysis systems that use Zero-Point Energy (ZPE) to weaken the molecular bond of water. These systems employ low voltage charged metal plates submerged in water, generating self-canceling waves through the Casimir effect, which reduces the bond strength in water molecules. This allows for a more efficient electrolysis process by requiring less energy to split the water into hydrogen and oxygen gases.

Some embodiments include a hydrogen and oxygen generation plant that utilizes alkaline or other electrolytic processes, wherein the water is first subjected to zero-point energy technology. This application of zero-point energy weakens the molecular bond between hydrogen and oxygen, significantly reducing the electrical input required for the subsequent electrolytic separation of the water molecule. As a result, large-scale hydrogen production from water is enabled using alternative power sources such as solar, wind, tidal, geothermal, among others, as well as night-time grid power, which can be stored in batteries for use during peak demand periods.

Some embodiments include the use of hydrogen as an energy storage medium, where it can be converted back to electricity with minimal voltage loss, providing an uninterrupted power supply (UPS) or addressing high demand during electrical consumption through a fuel cell. Hydrogen may also be combined with oxygen in an oxygen-enriched gas turbine to generate electricity. This process, which incorporates zero-point energy technology, is entirely renewable and 100% free of carbon emissions. The energy system is reliable and consistent, regardless of the time of day or year.

Example embodiments may utilize multiple energy sources, including solar, wind, and electrical utility power, to optimize energy costs. In another embodiment, the hydrogen production equipment operates continuously, producing hydrogen for storage and electricity generation when alternative energy sources are less available. Hydrogen gas can be used for various applications, such as powering low-emission vehicles, supplying energy to the plant where it is produced, and for numerous chemical processes. The resulting oxygen is clean and can also be purified for chemical and medical applications. Both hydrogen and oxygen provide additional revenue opportunities for the plant.

Some embodiments provide a method for producing hydrogen from water without the release any carbon byproducts. This method avoids both the freeing of carbon in natural gas deposits and the release of carbon during hydrogen production. In addition, water is an abundant and inexpensive resource that does not require costly processing or shipping, unlike natural gas. This approach not only eliminates the environmental impact associated with carbon emissions but also simplifies the logistics and reduces the overall cost of hydrogen production.

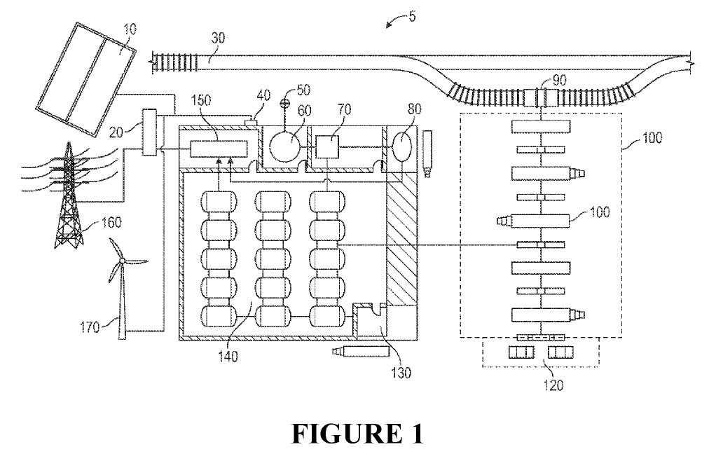

FIG. 1 shows an exemplary layout of the system 5, which is powered by, at various times, a solar collecting system 10, wind power 170, and/or the utility interconnect 20 that also carries power to the utility grid 160. These are connected to the energy generation system via the service panel distribution box 40. Also included is a fuel cell 150 and alkaline water electrolyzer 70, which are discussed in detail below. Because the system saves energy for later use in the form of hydrogen gas from water, embodiments may include a water storage container 60, as well as a groundwater source 50. Some embodiments may include an external source of water. The system also includes a hydrogen storage containment area 140 and hydrogen tubular trailer fills 100. Hydrogen and oxygen gas or liquid hydrogen can be obtained and shipped out via rail cars 90 on a rail line 30 or via trucks and small vehicles 120. Other embodiments may include shipping using other vehicles. Splitting water also produces oxygen gas, for which there is an oxygen storage facility 80. A separate room 130 houses hydrogen cylinder filling and storage. Ground water from source 50 is purified and degassed after entering the storage tank 60 and before entering the electrolyzer 70. In some embodiments, the electrolyzer 70 has a secondary tank (not shown).

In some embodiments, removing ions is not necessary if they are appropriate to the alkaline electrolysis. The purified water is subjected to low-voltage current through a metal stack (not shown) that creates vibrating zero point energy quantum waves that weaken the molecular force binding hydrogen and oxygen in the water molecule. The energy of the molecule is reduced toward ground state energy level, the lowest possible energy that a quantum mechanical system has. With that strong bond weakened, much lower voltage is needed to separate hydrogen and oxygen by vibration. Lower voltage requires less energy and thereby provides a significantly beneficial cost savings compared to other technology for splitting the water molecule.

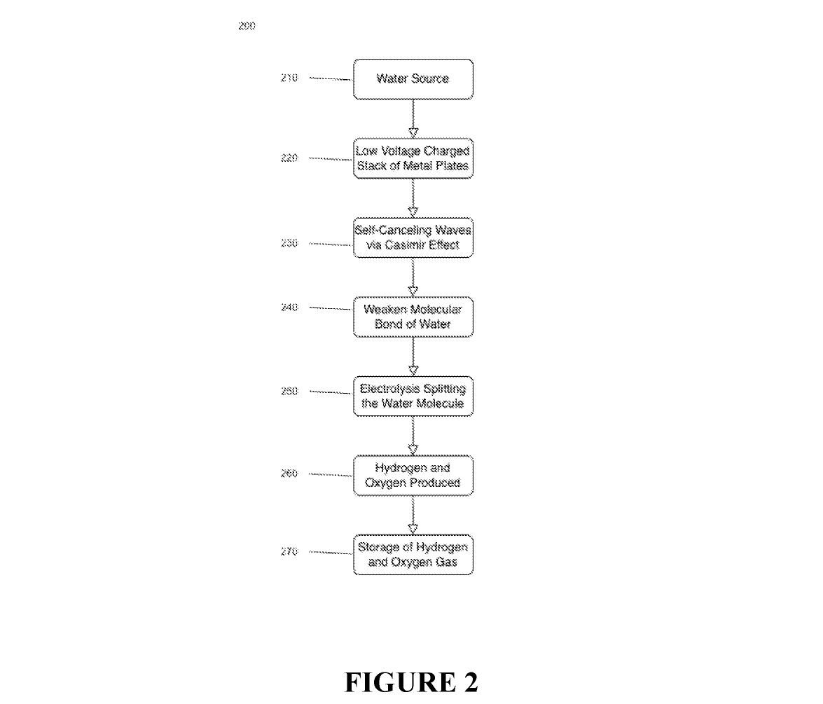

FIG. 2 illustrates a system 200 for producing hydrogen and oxygen gas from water using an electrolysis process. The system begins with a water source, as shown in block 210, where water is made available for processing. The next step, shown in block 220, involves the application of a low voltage charged stack of metal plates, which are submerged in the water. These plates create a specific quantum environment by applying a low voltage current. In block 230, the system generates self-canceling waves via the Casimir effect, which occurs between the plates. These waves weaken the molecular bond of the water, as depicted in block 240, making it easier to split the water molecules.

With the molecular bonds weakened, the electrolysis process becomes more efficient, as described in block 250, where the water molecules are split into hydrogen and oxygen gases. Block 260 indicates that the hydrogen and oxygen gases are then produced through the electrolysis process. Finally, block 270 shows that the produced gases are captured and stored for future use or for energy generation applications.

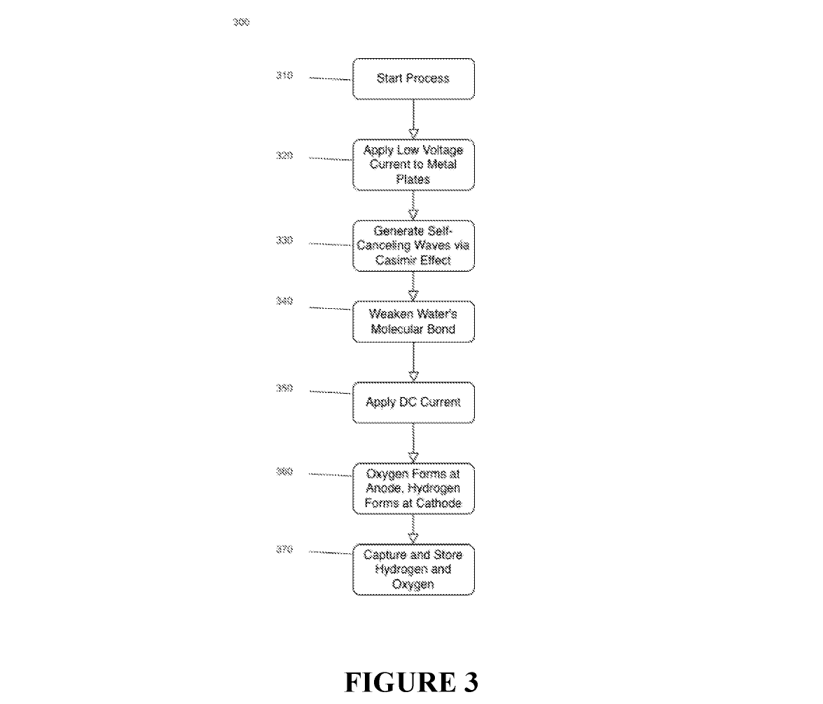

FIG. 3 represents a method 300 for producing hydrogen and oxygen gas through a step-by-step process. The method begins, as shown in block 310, with the initiation of the hydrogen and oxygen production process. The next step, block 320, involves applying a low voltage current to metal plates that are submerged in water. Block 330 illustrates the generation of self-canceling waves via the Casimir effect, which weakens the molecular bond in the water, as shown in block 340.

Following this, block 350 depicts the application of direct current (DC) to further facilitate the electrolysis process. At block 360, the process leads to the formation of oxygen at the anode and hydrogen at the cathode. Finally, block 370 shows that the hydrogen and oxygen gases are captured and stored separately for various future applications, including energy generation and industrial use.

Alkaline electrolysis of water is a well-established process for producing pure hydrogen and oxygen, and ongoing research seeks to enhance its efficiency. Although hydrogen is currently collected more efficiently using natural gas, natural gas contributes to air pollution and is subject to higher price volatility compared to water. Additionally, hydrogen and oxygen derived from fossil fuels may be contaminated with carbon monoxide, a problem that does not arise with water electrolysis. Previous methods of water electrolysis have required significant energy or overpotential to sufficiently activate the molecules for separation. However, when low voltage current is applied in some embodiments, the energy costs associated with water electrolysis are significantly reduced.

In some embodiments, following the application of low voltage to reduce the energy required for oxygen-hydrogen separation, a DC current is applied to facilitate oxygen formation at the positive anode and hydrogen gas formation at the negative cathode. The chemical reactions at each electrode differ: at the anode, an oxidation reaction occurs, generating oxygen and allowing electrons to enter the anode, thereby supplying electrical current. At the cathode, electrons are provided to hydrogen protons, resulting in the formation of H2 gas through a reduction reaction. In some embodiments, the oxygen and hydrogen gases are collected separately to provide distinct supplies of oxygen and hydrogen.

In some embodiments, additional factors may be adjusted to further increase efficiency. The system's pressure can be raised to partially compress the hydrogen gas as it is produced. Electrolytes may also be added to pure water to enhance electrical conductivity, such as salts, acids, or bases. Suitable salt cations may have a lower electrode potential than H+, including but not limited to Li+, Rb+, K+, Cs+, Sr++, Ba++, Na+, Ca++, and Mg++. In some embodiments, the use of an acid may be preferred, as it introduces additional H+ ions. Common alkaline solutions include potassium hydroxide (KOH) and sodium hydroxide (NaOH). Sodium chloride (NaCl) is less preferred due to the potential release of harmful chloride gas. The use of electro-catalysts may also be employed to increase efficiency and further reduce the electrical energy requirements.

In some embodiments, the alkaline electrolytic chamber includes two electrodes, an anode and a cathode, separated by a thin, porous foil with a preferred thickness ranging from 0.050 to 0.5 mm. The foil is non-conductive to ions, preventing electrical shorts between the anode and cathode. The foil may serve to separate the two gases produced, which could form an explosive mixture if combined. Example embodiments may use ZIRFON, a composite made of zirconium and polysulfone. The electrodes are preferably made from materials such as nickel, which offers greater stability to oxygen exposure compared to other related metals.

In some embodiments, for larger-scale electricity generation, the single fuel cell described may be stacked with multiple other fuel cells to increase output. Alternatively, the entire structure, as depicted in the accompanying drawings, may include a canopy equipped with solar panels. This canopy may also cover areas designated for loading hydrogen onto rail cars and trucks for transport.

Some embodiments may include a system for producing hydrogen and oxygen gas from water through electrolysis. The system may comprise a water source and a low voltage charged stack of metal plates submerged in the water. These plates generate self-canceling waves via the Casimir effect, which weakens the molecular bond of the water, thereby reducing the energy required for splitting the water molecules into hydrogen and oxygen gas. The produced gases may then be captured for storage or various applications such as energy storage, vehicle fuel, or industrial uses. In certain embodiments, the system may utilize power from renewable sources, including wind, solar, tidal, geothermal, or grid power, to perform the electrolysis process, making it suitable for alternative energy systems.

Some embodiments may further incorporate an alkaline electrolytic process to enhance the separation of hydrogen and oxygen from water. The system could also include additional components such as a pressurization mechanism to compress the hydrogen as it is produced, and the use of electrolytes like potassium hydroxide (KOH) or sodium hydroxide (NaOH) to improve conductivity and efficiency. The hydrogen and oxygen gases generated by this process can be captured separately, with potential applications ranging from transportation to energy storage. In some cases, the system may include a hydrogen storage unit for feeding fuel cells, enabling electricity generation during peak demand or times when renewable energy sources are less available.

Some embodiments may also involve a method for increasing the efficiency of water electrolysis, where low voltage current is applied to weaken the water's molecular bond using zero-point energy. Electrolytes may be added to increase electrical conductivity, and the system pressure can be raised to compress the hydrogen gas during production. This method allows for more efficient hydrogen production, enabling the use of hydrogen in fuel cells or oxygen-enriched gas turbines to generate electricity with zero carbon emissions. The hydrogen and oxygen gases produced through this method can be stored and utilized in various energy and industrial applications, contributing to a sustainable energy ecosystem.

The Casimir effect is a quantum mechanical phenomenon that arises from the quantum fluctuations of the vacuum, which are intrinsic to the fabric of space itself. In classical physics, a vacuum is simply the absence of matter, but in quantum mechanics, even a vacuum is not truly empty. Instead, it is filled with fluctuating energy and virtual particles that constantly appear and disappear. These fluctuations are known as zero-point energy, the lowest possible energy that a quantum mechanical physical system may have. The Casimir effect results from these zero-point energy fluctuations when two uncharged, parallel conducting plates are placed very close to each other in a vacuum.

In this scenario, the space between the plates restricts the range of quantum fluctuations that can occur, specifically limiting the wavelengths of virtual particles that can fit between the plates. Outside the plates, there are no such restrictions, and all wavelengths of quantum fluctuations are present. As a result, there is more energy outside the plates than inside. This imbalance creates a force that pushes the plates together, which is referred to as the Casimir force. The magnitude of this force increases as the plates get closer to each other, demonstrating that even in a vacuum, forces can emerge from the quantum nature of space itself. The Casimir effect was first theorized by Dutch physicist Hendrik Casimir in 1948, and has since been experimentally verified.

The Casimir effect is a manifestation of the boundary conditions imposed on the quantum vacuum, leading to a difference in the density of virtual particles between different regions of space. These boundary conditions result in an observable force that is measurable between conducting surfaces at very small distances, typically on the order of nanometers. While the Casimir effect is usually quite weak, it becomes significant at such small scales due to the sheer magnitude of quantum fluctuations in the vacuum.

When discussing self-canceling waves in the context of the Casimir effect, it is essential to explore how these quantum vacuum fluctuations behave between the plates. Normally, in open space, quantum fields fluctuate freely, with waves of all wavelengths and frequencies propagating without restriction. However, when the Casimir plates are introduced, only certain wave modes can exist between the plates due to the boundary conditions imposed by their proximity. The plates act as a filter, allowing only specific wavelengths of virtual particles that fit between them, while all other wavelengths are excluded.

The wavelengths that do not fit between the plates are effectively “canceled out” or suppressed. This suppression is what leads to the energy density inside the plates being lower than the energy density outside. These self-canceling waves are not physically observable in the traditional sense but are rather a result of the quantum field's response to the constraints placed by the plates. The excluded quantum fluctuations between the plates lead to fewer virtual particles and a lower energy state in that region. Outside the plates, however, no such constraints exist, and the quantum fluctuations are more abundant, resulting in a higher energy density.

The interaction between the plates and the quantum vacuum can be thought of as a kind of standing wave interference pattern, where the geometry of the plates causes destructive interference for certain wavelengths. This is somewhat analogous to how destructive interference occurs in classical wave phenomena, such as sound or water waves. In destructive interference, two waves of the same frequency and amplitude meet out of phase, canceling each other out. In the quantum realm, the boundary conditions imposed by the plates similarly create conditions where certain quantum fluctuations are suppressed, or "canceled," because the allowed modes of oscillation between the plates are limited.

These self-canceling waves result in the net Casimir force. The balance between the energy inside and outside the plates is skewed, creating the observed attraction between the plates. From a quantum field theory perspective, this force can be understood as the difference in the vacuum energy between the inside and outside regions of the plates, where the allowed quantum fluctuations are fewer inside than outside due to the restricted space. The Casimir effect, therefore, not only provides a window into the nature of quantum vacuum energy but also into the way boundary conditions in space can fundamentally alter the behavior of quantum fields.

In systems such as zero-point energy applications for electrolysis, the Casimir effect can be harnessed to alter the properties of matter on a quantum level. By weakening the molecular bonds in water, for example, the self-canceling waves between conducting plates submerged in water create a situation where the energy required to split the water molecules is reduced. The molecular bonds between hydrogen and oxygen, which are normally quite strong, become easier to break because the quantum fluctuations that would typically reinforce those bonds are suppressed by the Casimir effect.

This is a profound application of quantum mechanics to macroscopic systems, where the typically tiny forces of the quantum realm are amplified to a level where they can affect chemical reactions. In water electrolysis, this reduction in bond strength allows for a significant decrease in the energy required to split water into hydrogen and oxygen gases. The Casimir effect effectively reduces the zero-point energy available to the water molecules, pushing them closer to a state where their bonds are less stable, thus requiring less external energy to initiate the separation process.

In the process described, the self-canceling waves work by constantly reducing the number of available quantum fluctuations that would otherwise contribute to the stability of the water molecule’s bond. This results in a weakened molecular bond, a state of reduced energy for the water molecule that is closer to the ground state. When the electrolysis process begins, the amount of energy required to break these bonds is much lower than in standard conditions, thereby making the entire process far more energy-efficient.

Some embodiments are directed to tracking developments in the power generation industry, identifying challenges related to efficiency and energy consumption, and proposing solutions. These embodiments explore methods for improving day-round power generation with minimal energy input, focusing on hydrogen and oxygen generation using an electrolytic process combined with zero-point energy technology.

In some embodiments, a hydrogen and oxygen generation plant utilizes alkaline or other electrolytic processes, with water first subjected to zero-point energy technology. This approach weakens the molecular bond between hydrogen and oxygen, significantly lowering the electrical input needed for subsequent electrolysis. The technology enables large-scale hydrogen production using alternative power sources such as solar, wind, tidal, geothermal, and off-peak grid power stored in batteries for later use.

Some embodiments include hydrogen as an energy storage medium, which can be converted back to electricity with minimal voltage loss, ensuring uninterrupted power supply (UPS) during high demand periods. In some embodiments, hydrogen is used in fuel cells or combined with oxygen in oxygen-enriched gas turbines to generate electricity. The zero-point energy-based system is entirely renewable, carbon-neutral, and dependable year-round.

In some embodiments, the system utilizes multiple energy sources, such as solar, wind, and grid power, to optimize power costs. In certain embodiments, the equipment operates continuously, producing hydrogen for storage and electricity generation when other energy sources are scarce. The hydrogen produced can be used for various purposes, including low-emission vehicles, plant operations, and chemical applications. The oxygen byproduct can also be purified for industrial or medical uses, providing additional revenue streams.

This method of hydrogen production is superior to natural gas-based methods, as it avoids releasing carbon byproducts. Some embodiments emphasize that hydrogen production from water is cost-effective, with water being widely available and requiring fewer expensive processing steps.

Some embodiments show an exemplary layout of the system, powered by various sources such as solar collection systems, wind power, and utility interconnects. The system includes essential components such as a fuel cell, alkaline water electrolyzer, and a water storage container connected to a groundwater source. Hydrogen storage is extensive, with containment areas, tubular trailer fills, and transportation options via rail cars or trucks. The oxygen byproduct is stored separately in an oxygen storage facility. A designated room houses the hydrogen cylinder filling and storage.

In some embodiments, water from the groundwater source is purified and degassed before entering the electrolyzer. Ions may be removed if required by the electrolysis process. The purified water is subjected to a low-voltage current that creates zero-point energy quantum waves, weakening the molecular force binding hydrogen and oxygen in the water molecule. The energy of the water molecule is reduced to near-ground state levels, allowing the hydrogen and oxygen to be separated with significantly less energy.

Alkaline electrolysis is a well-known process for hydrogen production. Some embodiments further emphasize its efficiency compared to hydrogen extraction from natural gas, which releases pollutants and has higher price volatility. Electrolysis of water avoids carbon monoxide contamination, improving gas purity. The use of low-voltage current reduces the overall cost of the process.

Some embodiments apply low-voltage current to reduce energy requirements for oxygen-hydrogen separation, followed by direct current (DC) to enable the formation of oxygen at the anode and hydrogen gas at the cathode. The gases are collected separately to produce supplies of hydrogen and oxygen.

Various parameters can be optimized for greater efficiency. In some embodiments, system pressure is increased to partially compress hydrogen as it forms, and electrolytes such as salts, acids, or bases are added to improve electrical conductivity. Preferred electrolytes include potassium hydroxide (KOH) and sodium hydroxide (NaOH). Some embodiments include electro-catalysts to reduce the electrical requirement further.

In some embodiments, the electrolytic chamber contains two electrodes separated by a thin, porous foil that prevents electrical shorts and gas mixing. Preferred materials for the foil include zirconium-based composites, and nickel is favored for the electrodes due to its stability in oxygen-rich environments.

Some embodiments include fuel cell stacks for larger electricity generation. Alternatively, a canopy structure may house solar panels while also covering loading areas for hydrogen transport. Although specific embodiments have been illustrated, any arrangement that achieves similar purposes can be substituted.

Although specific embodiments have been illustrated and described herein, those skilled in the art will recognize that any arrangement designed to achieve the same purposes may be substituted for the embodiments shown. This disclosure is intended to encompass all adaptations and variations of various embodiments, and the descriptions provided are illustrative rather than restrictive. Combinations of the disclosed embodiments, as well as other embodiments not explicitly described, will be apparent to those skilled in the art upon reviewing this disclosure. The scope of the invention extends to any application where the described structures and methods are used, and should be determined with reference to the appended claims and their full range of equivalents.

In the foregoing description, if multiple features are grouped together within a single embodiment to streamline the disclosure, this should not be interpreted as implying that the claimed invention requires more features than those explicitly stated in each claim. The following claims, as well as any claims that may later be added, are incorporated into the description, with each claim serving as a separate embodiment of the invention.

Reference throughout this specification to terms such as "embodiment," "example," or similar language signifies that a specific feature, structure, characteristic, or combination thereof described in relation to an embodiment is present in at least one embodiment of the invention. The use of "embodiment" or "example" does not necessarily refer to the same embodiment each time it appears and may refer to different embodiments or figures. Additionally, the use of such terms does not imply that any described features are necessarily related or dissimilar.

Each statement of an embodiment or example is considered independent of other statements, even if similar language is used. Where an embodiment is identified as "another embodiment," it is independent of other embodiments similarly characterized. The described features and functions can be combined in whole or in part with others as the claims and related art may direct, either explicitly or implicitly.

As used herein, terms like "comprising," "including," "containing," "is," "are," "characterized by," and their grammatical equivalents are open-ended and inclusive terms that do not exclude additional unrecited elements or method steps. "Comprising" is to be broadly interpreted, encompassing the more restrictive terms "consisting of" and "consisting essentially of."

Reference throughout this specification to features, advantages, or similar language does not imply that all features and advantages must be realized in a single embodiment of the invention. Instead, such language indicates that a specific feature, advantage, or characteristic is included in at least one embodiment. Accordingly, discussion of such features and advantages may refer to different embodiments.

What is claimed is:

1. A system for producing hydrogen and oxygen gas from water using electrolysis, comprising:
a water source with at least one water molecule having a molecular bond;
a low voltage charged stack of metal plates, the metal plates being submerged in water;
a mechanism for generating self-canceling waves via the Casimir effect, the self-canceling waves being generated between the metal plates, and
a means to capture produced hydrogen and oxygen gases for storage;
wherein the self-canceling waves weaken the molecular bond of the at least one water molecule.

2. The system of claim 1, wherein the at least one water molecule is subjected to zero-point energy.

3. The system of claim 2, further comprising an alkaline electrolytic process for splitting the water molecule into hydrogen and oxygen gas.

4. The system of claim 3, wherein the hydrogen and oxygen gases are captured for various applications including at least one of energy storage, vehicle fuel, or industrial uses.

5. The system of claim 3, further comprising a power source selected from at least one of wind, solar, tidal, geothermal, or grid power, the power source being used to provide energy for the electrolysis process.

6. The system of claim 3, wherein the electrolysis is powered by renewable energy sources, and the hydrogen produced is stored for use during peak electricity demand.

7. The system of claim 1, further comprising:
an alkaline electrolysis chamber with an anode and a cathode, wherein the anode and cathode are separated by a thin-porous foil that prevents electrical shorts and gas mixing;
a means for applying a low voltage current to weaken the water molecule's molecular bond using zero-point energy; and
a means for capturing and storing the produced hydrogen and oxygen gases.

8. The system of claim 7, wherein the thin-porous foil is composed of ZIRFON.

9. The system of claim 7, wherein the electrodes are made from nickel.

10. The system of claim 7, further comprising a pressurization mechanism to compress hydrogen gas as it is produced.

11. The system of claim 7, wherein the electrolytic process uses at least one of potassium hydroxide (KOH) or sodium hydroxide (NaOH) as an electrolyte.

12. The system of claim 7, wherein the hydrogen is used in fuel cells or oxygen-enriched gas turbines to generate electricity with net zero carbon emissions.

13. A method for producing hydrogen and oxygen gas from water, the method comprising:
applying a low voltage current to a stack of metal plates, the metal plates being submerged in water, the water having at least one water molecule with a molecular bond;
generating self-canceling waves using the Casimir effect, the self-canceling waves being generated between the metal plates; and
applying direct current (DC) to enable the separation of oxygen at the anode and hydrogen at the cathode;
wherein the self-canceling waves weaken the molecular bond of the at least one water molecule.

14. The method of claim 13, wherein the weakened molecular bond reduces the energy required for electrolysis.

15. The method of claim 13, further comprising capturing the hydrogen and oxygen gases produced for use in at least one of energy storage or fuel applications.

16. The method of claim 13, wherein the hydrogen gas is used as a replacement for fossil fuels.

17. A method of increasing electrolysis efficiency, the method comprising:
applying a low voltage current to water to weaken the molecular bond via zero-point energy;
adding electrolytes to increase conductivity; and
raising the pressure of the system to compress the hydrogen gas during production.

18. The method of claim 17, wherein the electrolytes used include at least one of potassium hydroxide (KOH) or sodium hydroxide (NaOH).

19. The method of claim 17, wherein the hydrogen and oxygen gases are captured separately for use in at least one of energy generation, industrial processes, or transportation.
